(19) United States
(12) Patent Application Publication
(10) Pub. No.: US 2010/0102110 A1
(43) Pub. Date: Apr. 29, 2010

(54) CARTON FOR A FOOD PRODUCT

(76) Inventor: Angela E. Learn, Gilbertsville, PA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/608,294

(22) Filed: Oct. 29, 2009

Related U.S. Application Data
(60) Provisional application No. 61/197,662, filed on Oct. 29, 2008.

(51) Int. Cl. B65D 5/42; B65D 5/66; B65D 5/54; B31B 1/26

(52) U.S. Cl. 229/106; 229/126; 229/235; 493/162

(57) ABSTRACT

A carton for containing a food product. The carton has panels that extend at least partially around an interior of the carton including side panels and at least one bottom panel. The carton has features for holding the food product.

### CROSS-REFERENCE TO RELATED APPLICATION

This application claims the benefit of U.S. Provisional Application No. 61/197,662, which was filed on Oct. 29, 2008.

### INCORPORATION BY REFERENCE

U.S. Provisional Application No. 61/197,662, which was filed on Oct. 29, 2008, is hereby incorporated by reference for all purposes as if presented herein in its entirety.

### BACKGROUND OF THE DISCLOSURE

The present disclosure generally relates to cartons for holding and dispensing food products.

### SUMMARY OF THE DISCLOSURE

In general, one aspect of the disclosure is directed to a carton for containing a food product. The carton comprises panels that extend at least partially around an interior of the carton. The panels comprise a bottom panel and side panels. The carton can be used as a scoop for gathering a food product by a food service employee and a food container for serving the food product to a customer.

Other aspects, features, and details of the present disclosure can be more completely understood by reference to the following detailed description of exemplary embodiments taken in conjunction with the drawings and from the appended claims.

Those skilled in the art will appreciate the above-stated advantages and other advantages and benefits of various additional embodiments reading the following detailed description of the embodiments with reference to the below-listed drawing figures. Further, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIGS. 1-2B are various views of features of a first embodiment of the disclosure.

FIGS. 3-4B are various views of features of a second embodiment of the disclosure.

FIGS. 5-8 are various views of features of a third embodiment of the disclosure.

FIGS. 9-11 are various views of features of a fourth embodiment of the disclosure.

Corresponding parts are designated by corresponding reference numbers throughout the drawings.

### DETAILED DESCRIPTION OF THE EXEMPLARY EMBODIMENTS

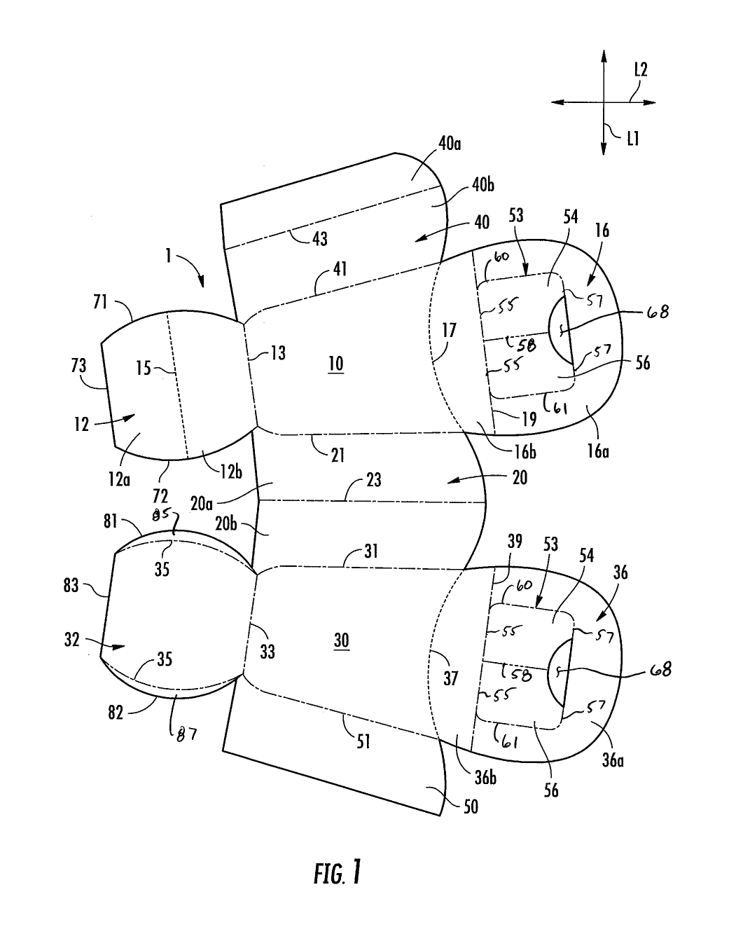

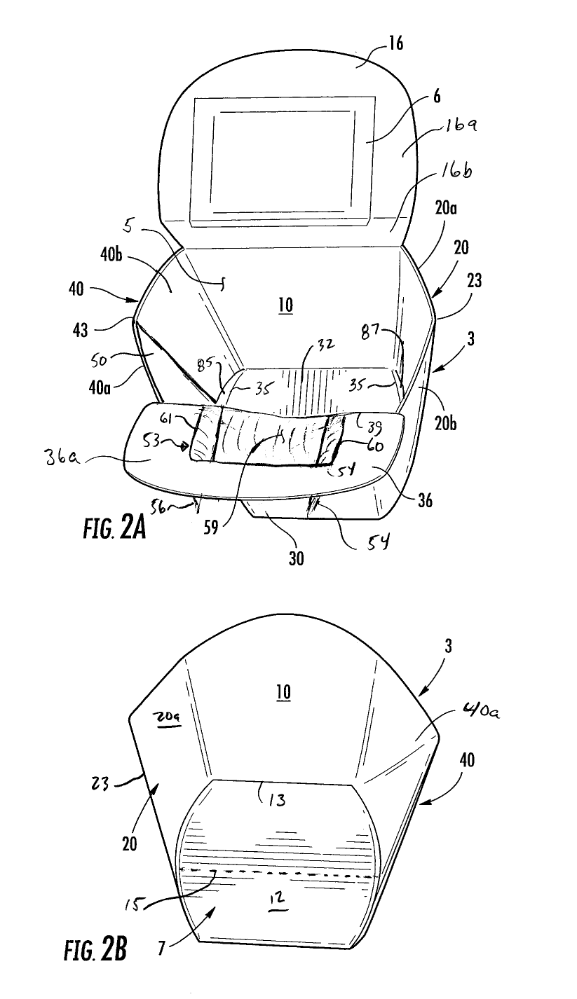

FIG. 1 is a plan view of a blank, generally indicated at 1, used to form a carton 3 (FIG. 2) of a first embodiment of the disclosure. The carton 3 can be used to hold a food product (not shown) such as a fast food product (e.g., fish, chicken, French fries, French toast sticks, sandwich, pizza, calzone, turnover, burrito, or any other food product that may be packaged for consumption by a consumer) in an interior 5 of the carton. The carton 3 can be sized to fit in a holder such as an automobile cup holder without departing from the scope of this disclosure. In one embodiment, the carton 3 can be used for holding and packaging fast food from a fast food service restaurant, but the carton could hold other types of food products or other non-food products without departing from the disclosure.

In the illustrated embodiment, the blank 1 has a longitudinal axis L1 and a lateral axis L2. The blank 1 includes a first side panel 10 foldably connected to a second side panel 20 at a first fold line 21, a third side panel 30 foldably connected to the second side panel 20 at a second fold line 31, and a fourth side panel 40 foldably connected to the first side panel 10 at a third fold line 41. An adhesive flap 50 is foldably connected to the third side panel 30 at a fourth fold line 51. In the illustrated embodiment, the second and fourth side panels 20, 40 have respective fold lines 23, 43 that divide each of the second and fourth side panels into respective portions 20a, 20b, and 40a, 40b. In the first embodiment, the portions 20a, 20b of the side panel 20 are angled with respect to each other when the carton 3 is formed from the blank 1 such that the side panel 20 is generally nonplanar. Similarly, the portions 40a, 40b are angled with respect to each other in the assembled carton 3 such that the side panel 40 is generally nonplanar. The blank 1 could have other side panel arrangements without departing from the disclosure.

The blank 1 includes a first bottom flap 12 foldably connected to the first side panel 10 at a fold line 13. A first top panel 16 is foldably connected to the first side panel 10 at a curved fold line 17. The first bottom flap 12 has two generally curved edges 71, 72 and one straight edge 73 generally parallel to the fold line 13. The first bottom flap 12 has a fold line 15 that divides the first bottom flap into two bottom flap portions 12a, 12b. The first top flap 16 has a fold line 19 that divides the first top flap into a first and a second portion 16a, 16b. The first portion 16a of the first top flap 16 has a pattern 53 of tear lines, cut lines, and fold lines that forms two flaps 54, 56 foldably connected to the first top flap. In one embodiment, the pattern 53 includes tear lines 55, 57, 58 and fold lines 60, 61. Each of the flaps 54, 56 is respectively foldably connected to the first portion 16a of the top flap 16 by a respective fold line 60, 61. In the illustrated embodiment, a cutout 68 is adjacent the flaps 54, 56 to facilitate folding the flaps. The pattern 53 could be otherwise shaped, arranged, configured, and/or omitted without departing from the disclosure. Further, the first and/or second portions 16a, 16b of the first top flap 16 could be otherwise shaped, arranged, and/or configured without departing from the disclosure.

The blank 1 includes a second bottom flap 32 foldably connected to the second side panel 30 at a fold line 33 and a second top flap 36 foldably connected to the second side panel 30 at a curved fold line 37. The second bottom flap 32 is shaped generally similar to the first bottom flap 12 with two curved edges 81, 82 and one generally straight edge 83 parallel to the fold line 33. The second bottom flap 32 includes two retention flaps 85, 87 at the marginal portions of the second bottom flap and at least partially defined by curved tear lines 35 near the respective curved edges 81, 82. The second bottom flap 32 is larger than the first bottom flap 12 in that the maximum distance between the curved edges 81, 82 of the second bottom flap 32 is greater than the maximum distance between the curved edges 71, 72 of the first bottom flap 12. The retention flaps 85, 87 are generally arcuate or crescent-shaped but the retention flaps could be otherwise shaped, arranged, and/or configured without departing from the disclosure. For example, the retention flaps 85, 87 could be rectangular shaped without departing from the disclosure.

In the illustrated embodiment, the second top flap 36 is shaped generally similar to the first top flap 16 in that the second top flap has a fold line 39 that separates the second top flap into respective portions 36a, 36b. The second top flap 36 includes a pattern 53 of tear lines and cut lines that forms two flaps 54, 56 similar to the flaps in the first top flap 16. The second top flap 36 could be otherwise shaped, arranged, and/or omitted without departing from the disclosure.

As shown in FIG. 2A, the carton 3 can be at least partially formed from the blank 1 by folding along fold lines 21, 31, 41, and 51 and adhering the adhesive flap 50 to the fourth side panel 40. Typically, the carton 3 will be shipped to a restaurant or other food service location in a partially assembled and laid-flat condition. Prior to placement of food product within the carton 3, the blank 1 is formed into a generally tubular structure having an open top and bottom end. The four side panels 10, 20, 30, 40 form the sides of the tubular structure. The bottom panel 7 of the carton that can be closed by overlapping the first and second bottom end flaps 12, 32. In one embodiment, the second bottom end flap 32 is closed first, with the two retention flaps 85, 87 of the second bottom end flap 32 being folded about fold lines 35 to be inserted into the tubular structure. In the closed bottom panel 7, the retention flaps 85, 87 are in face-to-face contact with a respective side panel 30, 40 to seal the bottom of the carton and to help secure the second bottom end flap 32 in the closed position.

Once the bottom panel 7 of the carton 3 is formed, the carton has the form of a closed-bottom scoop with an open top that can be used, for example, to scoop French fries, chicken, fish, or other food products (not shown) that are held in a warming area. Once the food product is scooped and received in the carton 3 the top flaps 16, 36 can be closed. Alternatively, the top flaps 16, 36 can remain open. The two flaps 54, 56 in each of the top flaps 16, 36 can be downwardly folded to form a respective receiving opening 59. One or more complimentary food product packages 6 (e.g., a container or package of condiments such as barbecue sauce, mustard, salad dressing, etc.), can be placed in the receiving openings 59. As shown in FIG. 2A, a food product package 6 has been receive in one of the openings 59 (e.g. the opening in the top flap 16) and the other of the flaps 54, 56 of the other top flap (e.g., top flap 36) have been downwardly folded to illustrate the opening 59. The condiment package 6 held in one or more of the openings 59 is conveniently located for access by the consumer who may grasp a food product, remove it from within the carton 3, and dip the food product in the condiment package 6 prior to consumption. Alternatively, the condiment packages 6 can be help in other flaps or opening features of the carton 3 or the condiment packages can be free standing, separate from the carton 3.

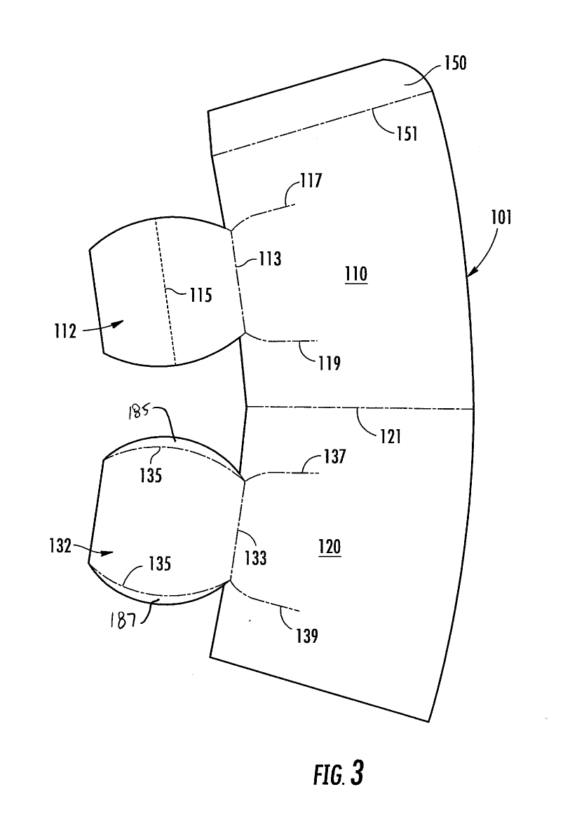

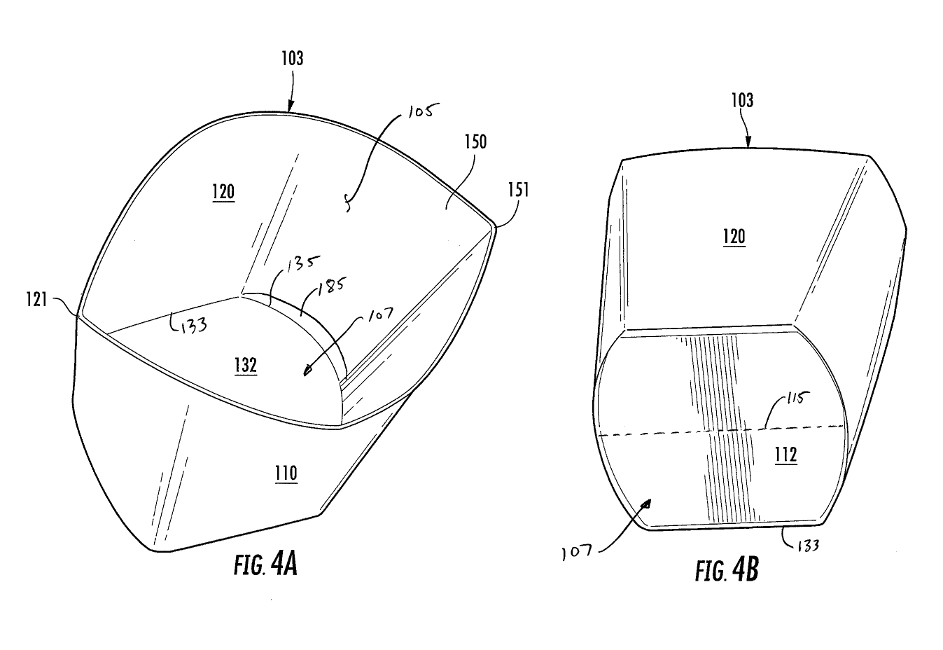

FIGS. 3-4B show a second embodiment of a blank 101 for use in forming a carton 103 that is similar to the carton 3 of the first embodiment. Accordingly, similar or identical features of the embodiments are provided with like reference numbers.

In the embodiment of FIGS. 3-4B, the blank 101 includes two side panels 110, 120 foldably connected at a fold line 121. An adhesive panel 150 is foldably connected to the first side panel 110 at a fold line 151. Two bottom end flaps 112, 132 are similar to the bottom end flaps 12, 32 and are foldably connected to respective side panels 110, 120 at fold lines 113, 133. The bottom flap 132 has retention flaps 185, 187 similar to the retention flaps 85, 87 and foldably connected to the bottom flap at fold lines 135. As shown in FIG. 4, the two side panels 110, 112 are generally curved and meet at respective edges corresponding to fold lines 121, 151.

The first side panel 110 includes fold lines 117, 119 extending from respective ends of the fold line 113 and partially into the side panel. The second side panel 120 has similar fold lines 137, 139 extending from respective ends of the fold line 133 and partially into the side panel. The fold lines 117, 119, 137, 139 aid in forming the curved side panels 110, 120 of the carton 103. The carton 103 and blank 101 could be otherwise shaped, arranged, and/or configured without departing from the disclosure.

The blank 101 is formed into the carton 103 in a similar manner as the blank 1 and carton 3 of the first embodiment. A generally open-ended tubular structure is formed by folding the blank 101 about fold lines 121, 151, 117, 119, 137, 139 and attaching the adhesive panel to the side panel 120. The bottom panel 107 of the carton 103 is closed by first folding the bottom end flap 132 inwardly in a manner that the retention flaps 185, 187 are placed in face-to-face contact with the interior surface of the side panels 110. The bottom end flap 112 is then folded over the bottom end flap 132 and can be secured by placing the edges of the bottom end flap 112 in contact with the side panels 110, 120 or can be secured to the bottom end flap 132 by adhesive. The side panels 110, 120 and overlapped bottom end flaps 112, 132 define the interior 105 of the carton 103. The carton 103 could be formed by alternative blank positioning steps without departing from the disclosure.

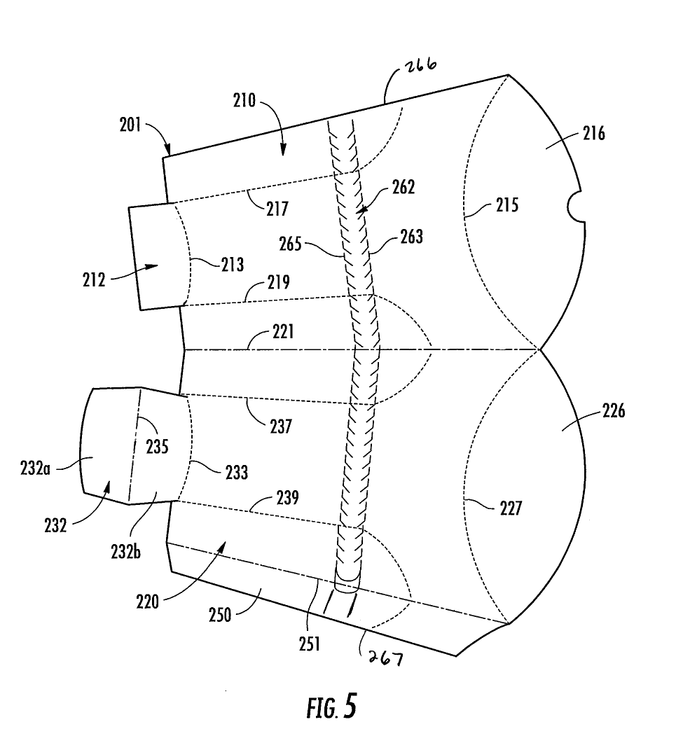

FIGS. 5-8 illustrate a third embodiment of a blank 201 for use in forming a carton 203 similar to the previous embodiments. Accordingly, similar or identical features of the embodiments are provided with like reference numbers.

In the embodiment of FIG. 5, the blank 201 comprises two side panels 210, 220 foldably connected at a fold line 221. An adhesive panel 250 is foldably connected to the second side panel 220 at a fold line 251. Two bottom end flaps 212, 232 are foldably connected to respective side panels 210, 220 at fold lines 213, 233. The second bottom end flap 232 includes a fold line 235 dividing the end flap into respective portions 232a, 232b. In the illustrated embodiment, the side panel 210 includes fold lines 217, 219 that extend from ends of the fold line 213 connecting the bottom flap 212. The side panel 220 includes fold lines 237, 239 that extend from the ends of the fold line 233 connecting the bottom flap 232. Three of the fold lines 219, 237, 239 extend to a respective fold line 221, 251 and the other fold line 217 extends to an edge of the first top panel 210. The fold lines 217, 219, 237, 239 facilitate forming the side panels 210, 220 into the curved side walls of the carton 203.

In the illustrated embodiment, a first top end flap 216 is foldably connected to the first side panel 210 at a curved fold line 215. A second top end flap 226 is foldably connected to the second top panel 220 at a curved fold line 227. In the embodiment of FIGS. 5-8, the blank 201 includes a tear strip 262 formed by spaced apart tear lines 263, 265 that extend from an edge 266 of the first side panel 210 to the fold line 251, and across the adhesive flap 250 to an edge 267 of the adhesive flap. The tear strip 262 could be otherwise shaped, arranged, configured, or omitted without departing from the scope of this disclosure.

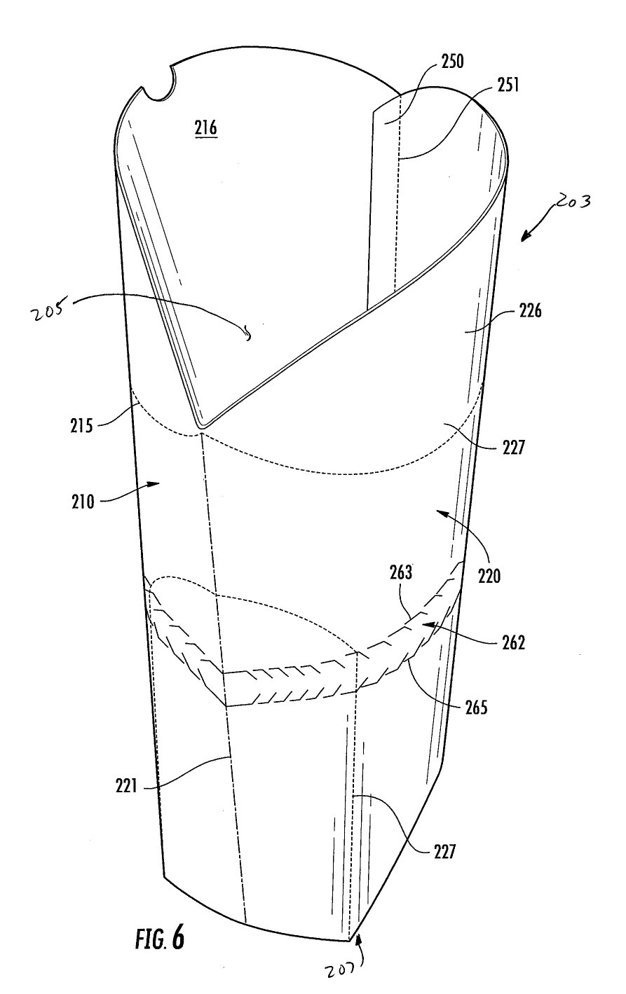

The blank 201 can be formed into the carton 203 in a similar manner as the previous embodiments. First, a generally open-ended tubular structure is formed by folding the side panels 210, 220 and adhesive panel 250 about fold lines 217, 219, 221, 237, 239, 251 so that the side panels are curved and the adhesive panel is attached to the first side panel 210. The bottom panel 207 of the carton 203 can be formed by first inwardly folding the bottom flap 232 about fold line 233 and then inwardly folding the bottom flap 212 about fold line 213. Other alternative closing configurations can be used and the bottom flap 232 can be configured to have retention flaps as shown in the previous embodiments. FIG. 6 shows the partially assembled carton 203 with the top end flaps 216, 226 opened. Food products (e.g., French fries, onion rings, chicken nuggets, etc.) can be placed in the partially assembled carton 203. When the top end flaps 216, 226 are open, the carton 203 is particularly suitable for scooping food products from a bin so as to place the food products in the interior 205 of the carton.

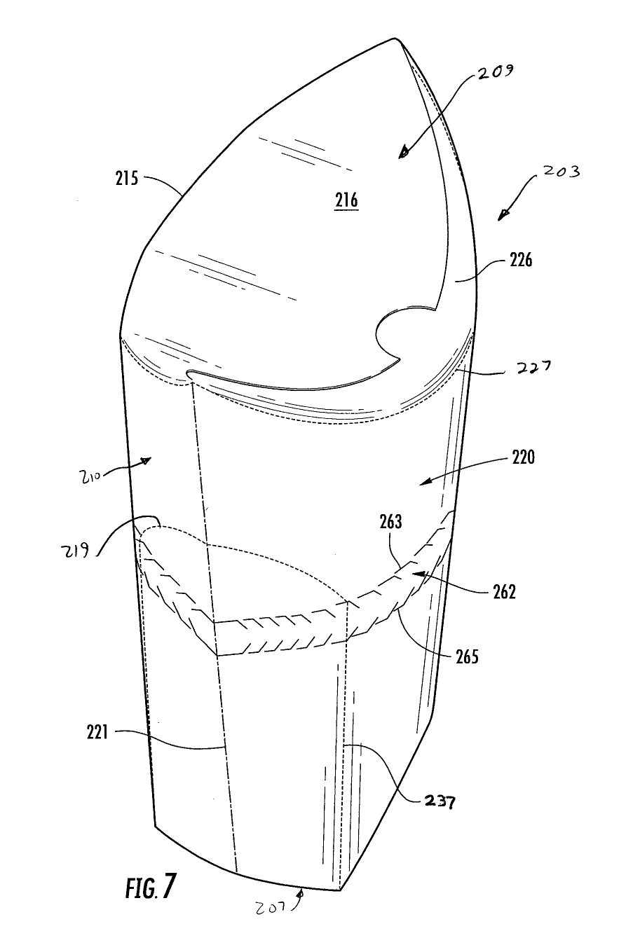

After placing a food product in the interior 205 of the carton 203 such that at least a portion of the food product is supported by the bottom panel 207, the top end flaps 216, 226 can be closed to form a substantially closed top 209 (FIG. 7) of the carton. The first top end flap 226 is downwardly folded about fold line 227 and the second top end flap 216 is downwardly folded about fold line 215 to overlap the first top end flap 226 and form the closed top 209. Alternatively, the top end flaps 216, 226 can be omitted or otherwise shaped and arranged without departing from the disclosure.

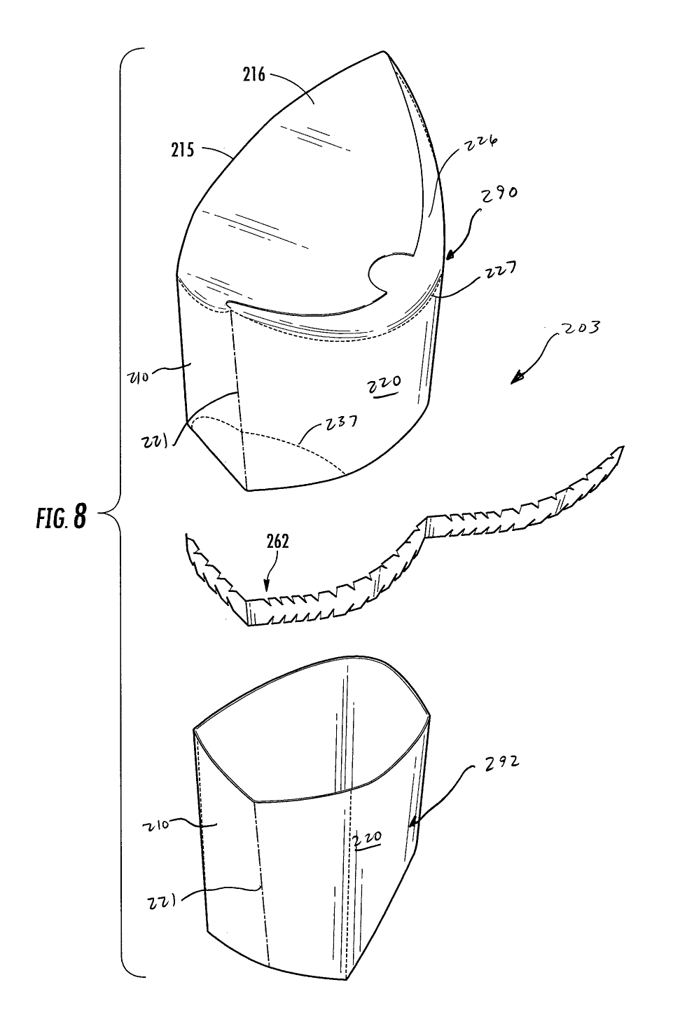

As shown in FIG. 8, after the blank 201 is formed into the carton 203, the tear strip 262 can be removed to separate the carton into two parts (e.g., an upper part 290 and lower part 292). The upper part 290 can be removed and the lower part 292 can be used to hold the remaining food product for consumption. Alternatively, the carton 203 can be opened by upwardly folding the top flaps 216, 226 to access the food product in the carton. The carton 203 can have other opening features and can be opened by other methods without departing from the disclosure.

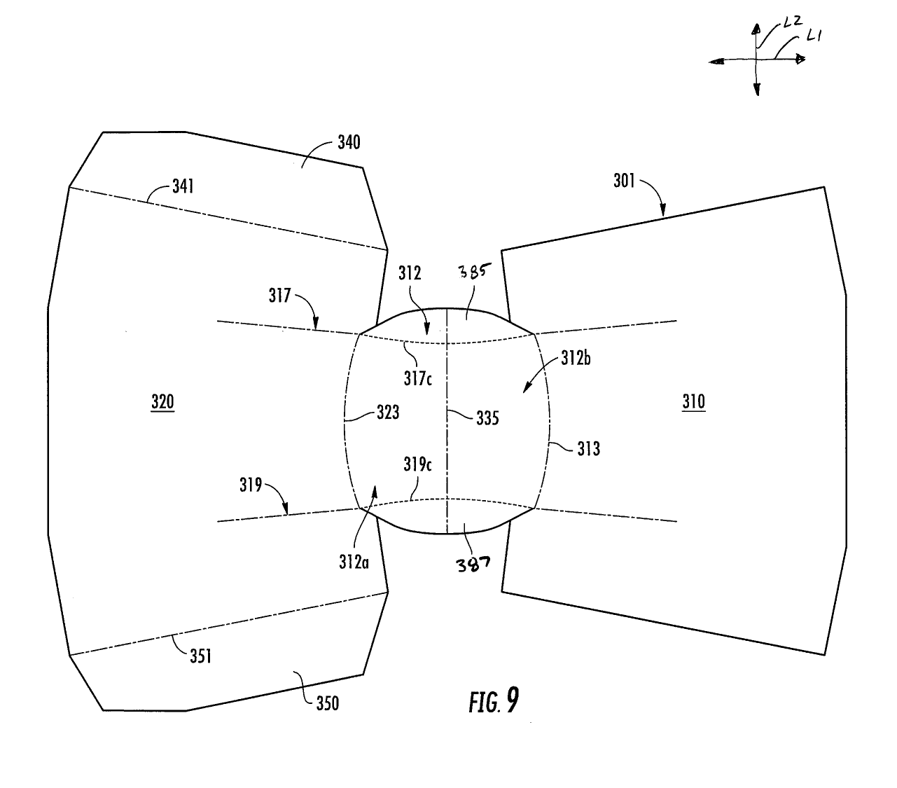

FIGS. 9-11 show a fourth embodiment of a blank 301 used in forming a carton 303 similar to previous embodiments. Accordingly, similar or identical features of the embodiments are provided with like reference numbers.

In the embodiment of FIG. 9, the blank 301 includes a first side panel 310 and a second side panel 320 respectively foldably connected to a bottom panel 312 at respective fold lines 313, 323. The blank 301 includes two adhesive flaps 340, 350 foldably connected to the second side panel 320 at respective fold lines 341, 351. The blank 301 includes a fold line 317 extending generally transversely across the blank from the second side panel 320 through the bottom panel 312 and into the first side panel 310. A fold line 319 is in a generally mirror-image relationship with the fold line 317, and extends from the second side panel 320, through the bottom panel 312 and into the first side panel 310.

In the illustrated embodiment, the bottom panel 312 has retention flaps 385, 387 foldably connected to the bottom panel by portions 317c, 319c of the respective fold lines 317, 319. The retention flaps 385, 387 comprise a marginal portion of the bottom panel 312. The bottom panel 312 includes a fold line 335 extending generally in the lateral direction L2 and dividing the bottom panel into two portions 312a, 312b. The blank 301 could be otherwise shaped, arranged, and or configured and could have other features without departing from the disclosure.

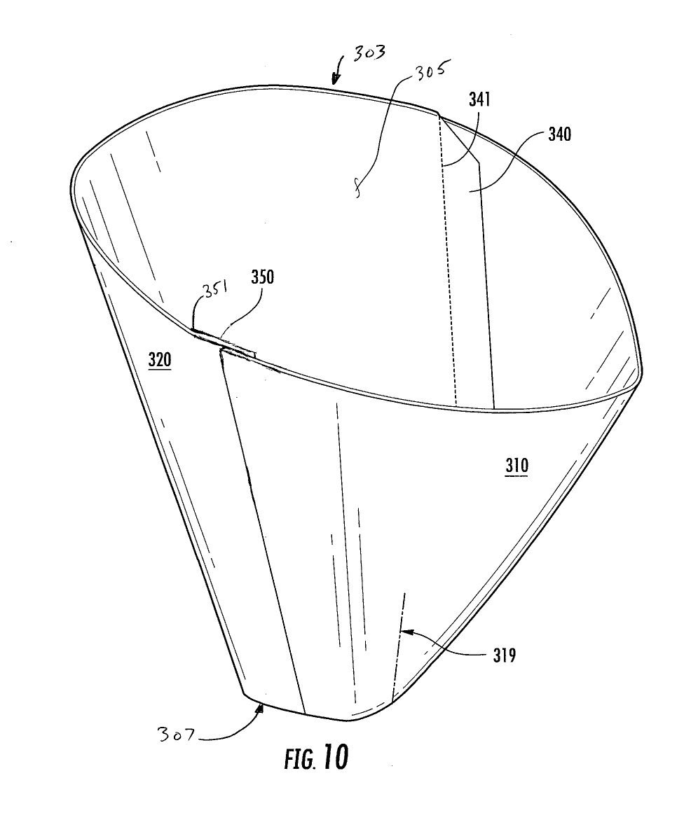

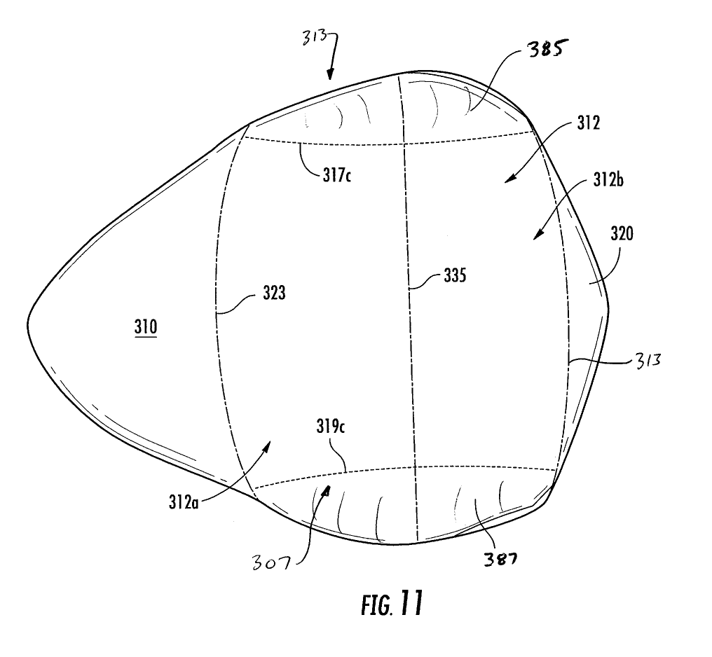

The blank 301 of FIG. 9 is formed into a carton 303 (FIGS. 10-11) in a similar manner as the previous embodiments. The bottom panel 312 forms the bottom 307 of the carton 303 and the first and second side panels 310, 320 form curved sides of the carton. As shown in FIG. 11, the retention flaps 385, 387 are positioned so that a portion of the retention flaps are in face-to-face contact with a portion of the inner surface of the side panels 310, 320. The retention flaps 385, 387 help retain the shape of the carton 303 and to seal the bottom 307 of the carton from leakage. The carton 303 has an open top that is shaped for scooping food products into the interior 305 of the carton. The carton formed from the blank 301 could be formed by other flaps positioning steps and could have other features without departing from the disclosure.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blanks. In accordance with the above-described embodiments, the blank may be constructed of paperboard of a caliper such that it is heavier and more rigid than ordinary paper. The blanks can also be constructed of other materials, such as cardboard, hard paper, or any other material having properties suitable for enabling the cartons, to function at least generally as described above. The blanks can also be laminated to or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the spaced apart slits to be replaced with a continuous slit, a continuous score, or the like. For example, a cut line can be a continuous slit or could be wider than a slit without departing from the present disclosure. Also, a tear line can be a series of cut scores passing completely, or partially, through the material, that are separated by nicks.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for holding a food product, the carton comprising
a plurality of panels that extends at least partially around an interior of the carton, the plurality of panels comprises at least two side panels and a bottom panel,
the bottom panel having at least two retention flaps foldably connected to the bottom panel, the at least two retention flaps being in face-to-face contact with a respective one of the at least two side panels.

2. The carton of claim 1 wherein the bottom panel comprises a first bottom flap and a second bottom flap, the at least two retention flaps being foldably connected to the second bottom flap, the first and second bottom flap being in an overlapping relationship to form the bottom panel.

3. The carton of claim 2 wherein the retention flaps are each generally crescent-shaped and are each foldably connected to the second bottom flap at a respective curved fold line.

4. The carton of claim 2 wherein the at least two side panels comprises a first side panel and a second side panel, the first bottom flap is foldably connected to the first side panel and the second bottom flap is foldably connected to the second side panel.

5. The carton of claim 4 wherein one of the retention flaps is in face-to-face contact with the first side panel and the other of the retention flaps is in face-to-face contact with the second side panel.

6. The carton of claim 2 wherein the at least two side panels comprises a first side panel, a second side panel, a third side panel, and a fourth side panel, the first bottom flap is foldably connected to the first side panel and the second bottom flap is foldably connected to the third bottom panel.

7. The carton of claim 6 wherein one of the retention flaps is in face-to-face contact with the second side panel and the other of the retention flaps is in face-to-face contact with the fourth side panel.

8. The carton of claim 6 wherein the second side panel is foldably connected to the first side panel and the third side panel, and the fourth side panel is foldably connected to the first side panel.

9. The carton of claim 6 wherein the carton comprises a first top flap foldably connected to the first side panel and a second top flap foldably connected to the third side panel.

10. The carton of claim 9 wherein at least one of the first top flap and the second top flap has two flaps foldably connected to the at least one of the first top flap and the second top flap, the two flaps forming an opening for receiving a complimentary food product package.

11. The carton of claim 1 wherein the at least two side panels are curved and the bottom panel is generally flat.

12. The carton of claim 1 wherein the bottom panel is foldably connected to the first side panel and the bottom panel is foldably connected to the second side panel.

13. A carton for holding a food product, the carton comprising
a plurality of panels that extends at least partially around an interior of the carton, the plurality of panels comprises at least two side panels, a bottom panel, and a top panel, and
a tear strip extending across the at least two side panels, the tear strip being for opening the carton and accessing the food product supported by the bottom panel.

14. The carton of claim 13 wherein the at least two side panels comprises a first side panel and a second side panel foldably connected to the first side panel, the bottom panel comprises a first bottom flap foldably connected to the first side panel and a second bottom flap foldably connected to the second side panel.

15. The carton of claim 14 wherein the top panel comprises a first top flap foldably connected to the first side panel and a second top flap foldably connected to the second side panel.

16. The carton of claim 15 wherein the first bottom flap and the second bottom flap are respectively foldably connected to one of the first side panel and the second side panel at a curved fold line.

17. The carton of claim 16 wherein the first top flap and the second top flap are respectively foldably connected to one of the first side panel and the second side panel at a curved fold line.

18. The carton of claim 17 wherein the first side panel is curved and the second side panel is curved.

19. A blank for forming a carton for holding a food product, the blank comprising
a plurality of panels comprising at least two side panels and a bottom panel,
the bottom panel having at least two retention flaps foldably connected to the bottom panel, the at least two retention flaps are for being in face-to-face contact with a respective one of the at least two side panels.

20. The blank of claim 19 wherein the bottom panel comprises a first bottom flap and a second bottom flap, the at least two retention flaps being foldably connected to the second bottom flap.

21. The blank of claim 20 wherein the retention flaps are each generally crescent-shaped and are each foldably connected to the second bottom flap at a respective curved fold line.

22. The blank of claim 20 wherein the at least two side panels comprises a first side panel and a second side panel, the first bottom flap is foldably connected to the first side panel and the second bottom flap is foldably connected to the second side panel.

23. The blank of claim 20 wherein the at least two side panels comprises a first side panel, a second side panel, a third side panel, and a fourth side panel, the first bottom flap is foldably connected to the first side panel and the second bottom flap is foldably connected to the third bottom panel.

24. The blank of claim 23 wherein the second side panel is foldably connected to the first side panel and the third side panel, and the fourth side panel is foldably connected to the first side panel.

25. The blank of claim 23 wherein the carton comprises a first top flap foldably connected to the first side panel and a second top flap foldably connected to the third side panel.

26. The blank of claim 25 wherein at least one of the first top flap and the second top flap has two flaps foldably connected to the at least one of the first top flap and the second top flap, the two flaps being for forming an opening for receiving a complimentary food product package.

27. The blank of claim 19 wherein the bottom panel is foldably connected to the first side panel and the bottom panel is foldably connected to the second side panel.

28. A blank for forming a carton for holding a food product, the blank comprising
a plurality of panels comprises at least two side panels, a bottom panel, and a top panel, and
a tear strip extending across the at least two side panels, the tear strip being for opening the carton and accessing the food product supported by the bottom panel.

29. The blank of claim 28 wherein the at least two side panels comprises a first side panel and a second side panel foldably connected to the first side panel, the bottom panel comprises a first bottom flap foldably connected to the first side panel and a second bottom flap foldably connected to the second side panel.

30. The blank of claim 29 wherein the top panel comprises a first top flap foldably connected to the first side panel and a second top flap foldably connected to the second side panel.

31. The blank of claim 30 wherein the first bottom flap and the second bottom flap are respectively foldably connected to one of the first side panel and the second side panel at a curved fold line.

32. The blank of claim 31 wherein the first top flap and the second top flap are respectively foldably connected to one of the first side panel and the second side panel at a curved fold line.

33. A method of forming a carton, the method comprising
obtaining a blank, the blank comprising
a plurality of panels that comprises at least two side panels and a bottom panel,
the bottom panel having at least two retention flaps foldably connected to the bottom panel, and
forming the blank into the carton such that the plurality of panels at least partially enclose an interior of the carton, the forming the blank into the carton comprises positioning the at least two retention flaps to be in face-to-face contact with a respective one of the at least two side panels.

34. The method of claim 1 wherein the bottom panel comprises a first bottom flap and a second bottom flap, the at least two retention flaps being foldably connected to the second bottom flap, the forming the blank into the carton comprises positioning the first and second bottom flaps to be in an overlapping relationship to form the bottom panel.

35. The method of claim 34 wherein the retention flaps are each generally crescent-shaped and are each foldably connected to the second bottom flap at a respective curved fold line.

36. The method of claim 34 wherein the at least two side panels comprises a first side panel and a second side panel, the first bottom flap is foldably connected to the first side panel and the second bottom flap is foldably connected to the second side panel.

37. The method of claim 36 wherein the forming the blank into the carton comprises positioning one of the retention flaps to be in face-to-face contact with the first side panel and positioning the other of the retention flaps to be in face-to-face contact with the second side panel.

38. The method of claim 34 wherein the at least two side panels comprises a first side panel, a second side panel, a third side panel, and a fourth side panel, the first bottom flap is foldably connected to the first side panel and the second bottom flap is foldably connected to the third bottom panel.

39. The method of claim 38 wherein the forming the blank into the carton comprises positioning one of the retention flaps to be in face-to-face contact with the second side panel and positioning the other of the retention flaps to be in face-to-face contact with the fourth side panel.

40. The method of claim 39 wherein the second side panel is foldably connected to the first side panel and the third side panel, and the fourth side panel is foldably connected to the first side panel.

41. The method of claim 36 wherein the carton comprises a first top flap foldably connected to the first side panel and a second top flap foldably connected to the third side panel, the forming the blank into the carton comprises placing the first top flap and the second top flap in an overlapping relationship to close the carton.

42. The method of claim 41 wherein at least one of the first top flap and the second top flap has two flaps foldably connected to the at least one of the first top flap and the second top flap, the forming the blank into the carton comprises folding the two flaps to form an opening and placing a complimentary food product package in the opening.

43. The method of claim 33 wherein forming the blank into to carton comprises positioning the at least two side panels so that the at least two side panels are curved and positioning the bottom panel to form a generally flap bottom of the carton.

44. The method of claim 33 wherein the at least two side panels comprises a first side panel and a second side panel, the bottom panel is foldably connected to the first side panel and the bottom panel is foldably connected to the second side panel, and forming the blank into the carton comprises adhesively connecting the first side panel to the seconds die panel and positioning the first side panel and the second side panel so the first and second side panels are curved.

45. A method of forming a carton for holding a food product, the method comprises
obtaining a blank, the blank comprising
a plurality of panels that comprises at least two side panels, a bottom panel, and a top panel, and
a tear strip extending across the at least two side panels,
forming the blank into the carton such that the plurality of panels at least partially enclose an interior of the carton, and
opening the carton by tearing the tear strip to allow access to the food product supported by the bottom panel.

46. The method of claim 45 wherein the at least two side panels comprises a first side panel and a second side panel foldably connected to the first side panel, the bottom panel comprises a first bottom flap foldably connected to the first side panel and a second bottom flap foldably connected to the second side panel, wherein forming the blank into the carton comprises at least partially overlapping the first bottom flap and the second bottom flap to form the bottom panel.

47. The method of claim 46 wherein the top panel comprises a first top flap foldably connected to the first side panel and a second top flap foldably connected to the second side panel, wherein forming the blank into the carton comprises at least partially overlapping the first top flap and the second top flap to close the top of the carton.

48. The method of claim 47 wherein the first bottom flap and the second bottom flap are respectively foldably connected to one of the first side panel and the second side panel at a curved fold line, and the first top flap and the second top flap are respectively foldably connected to one of the first side panel and the second side panel at a curved fold line.

49. The method of claim 45 wherein the forming the blank into the carton comprises positioning the first side panel to be curved and positioning the second side panel to be curved.

50. The method of claim 45 wherein the opening the carton comprises separating the carton into an upper portion and a lower portion.
